(19) United States
(12) Patent Application Publication
(10) Pub. No.: US 2004/0020085 A1
(43) Pub. Date: Feb. 5, 2004

(54) Greeting card product combining greeting card with functionality device

(76) Inventors: Joann Marie Ferguson, Glen Ellen, CA (US); Kristin Kave Nicholson, San Francisco, CA (US); Patricia L.F. Petersen, San Francisco, CA (US)

Correspondence Address: KRISTIN NICHOLSON, 44 SANCHEZ ST., SAN FRANCISCO, CA, 94114, US

(21) Appl. No.: 10/417,750

(22) Filed: Apr. 17, 2003

Related U.S. Application Data
(60) Provisional application No. 60/373,462, filed on Apr. 18, 2002.

(51) Int. Cl. G09F 1/00

(52) U.S. Cl. 40/124.06; 40/124.12

(57) ABSTRACT

A greeting card is formed to receive interactive computer-based functionality, as a functionality device, in a form such as a computer readable storage medium, for example, a compact disk (CD). Together this card and functionality device make an all-in-one gift and greeting card product, providing an improved gift/greeting card combination that meets multiple unmet needs of the greeting card consumer. The card is formed with a number of panels, one of which contains a means of receiving the functionality device. The functionality device provides functionality that relates to the occasion being commemorated or to the recipient's demographic profile. In one embodiment of the present invention, the greeting card product combines a congratulatory greeting card for expectant parents with a CD insert. The CD contains an interactive software application with a searchable database of names to help the parents choose a name for their baby in a new and fun way.

### CROSS-REFERENCE TO RELATED APPLICATIONS

With reference to and based on provisional patent filed on Apr. 18, 2002, application No. 60/373,462.

### FEDERALLY SPONSORED RESEARCH

Not Applicable

### SEQUENCE LISTING OF PROGRAM

Not Applicable

### BACKGROUND—FIELD OF INVENTION

This invention relates to greeting cards and gifts, specifically to an improved method of delivering a greeting, which combines a meaningful gift with the card.

### BACKGROUND—DESCRIPTION OF PRIOR ART

Numerous greeting card choices exist for the consumer, but there remain drawbacks or unfilled needs with many of these choices.

When a full gift is not appropriate, but a card is not enough, a suitable option is not readily available. Also, there are times when, after choosing the main gift, a little something more is necessary, but not warranting of another gift. The consumer may have a spending limit, such as for an office party, and a wide selection of gifts in the price range is not available.

The greeting card market exists to provide an avenue for individuals to express various emotions to others. Cards themselves do not typically present the recipient with more than a written message, and as such can fall short of conveying the true depth of the giver's intended expression.

The giver might like to commemorate an occasion, holiday or other event with a card, but would also like to continue commemorating after the time of the giving of the card.

A variety of cards have been made which are designed to hold a toy, novelty or gift item, such as a bookmark, a health test kit or a dog biscuit, as evidenced by U.S. Pat. Nos. 5,359,793, 5,954,369 and 4,203,516. Cards have also been constructed in the past in a manner, which enables an audiocassette to be contained therein, as evidenced by U.S. Pat. No. 4,433,780.

None of the aforementioned cards are widely available. In addition, these prior art greeting card and gift combinations are not easily mailed to card recipients due to bulky packaging and odd shapes. In the case of the audiocassette, in order for it to be personalized, the card giver would have to spend additional time recording a personal message on the cassette.

Cards holding an insert for money are both widely available and easily mailed, but a consumer might view this as too impersonal.

Cards containing a music insert have also been made in different forms, as evidenced by U.S. Pat. No. 6,003,254, which describes a greeting card with a sleeve designed to hold a record. However, music is also somewhat impersonal and does not differentiate the greeting card, and the recipient only has a passive relationship with the contents of the music insert.

Prior art also exists for which a CD serves as a customized gift to commemorate an occasion, such as a birthday, as evidenced in U.S. Pat. No. 6,453,300. However, this invention is not easily marketed in a commercial sense due to the complexity of the customization, which requires the buyer's input before purchase.

Thus, a primary object of the present invention is to provide an improved gift/greeting card combination and method of producing same.

### SUMMARY

The present invention is the combination of a greeting card and interactive computer-based functionality, preferably a card having a pocket formed therein. The card commemorates an occasion, holiday or other event and the accompanying functionality relates to the aforementioned occasion, or to the demographic profile of the recipients at whom the card is directed. The software that provides the interactive computer-based functionality may be stored on a computer readable storage medium, such as a compact disk.

In its most basic form, the invention is:

a) a greeting card with front and one or more interior surfaces that include indicia; and

b) a device that provides interactive computer-based functionality.

### DRAWINGS

Drawing Figures

FIG. 1a is a front view of a greeting card with the front cover closed;

FIG. 1b is a front view of the greeting card in FIG. 1a, with the front cover opened to reveal the interior indicia;

FIG. 1c is a front view of the greeting card in FIG. 1a, with an interior panel opened to reveal a compact disk in a pocket;

FIG. 1d is a view from the bottom of the greeting card in FIG. 1a that shows the folding points and folding directions of the card's panels, as well as the facing directions of the components of each panel;

FIG. 2a is a front view of a greeting card that shows an interior panel opened to reveal a compact disk in the pocket, and with an alternative layout to the interior shown in FIG. 1c;

FIG. 2b is a view from the bottom of the greeting card in FIG. 2a that shows the folding points and folding directions of the card's panels, as well as the facing directions of the components of each panel;

FIG. 3a is a front view of a greeting card that shows an interior panel opened to reveal a compact disk in a pocket, and with an alternative layout to the interior shown in FIG. 1c;

FIG. 3b is a view from the bottom of the greeting card in FIG. 3a that shows the folding points and folding directions of the card's panels, as well as the facing directions of the components of each panel.

### REFERENCE NUMERALS IN DRAWINGS

| | |
|---|---|
| 2 | Front Panel |
| 4 | Front Indicia |
| 6 | Interior Panel |
| 8 | Interior Indicia |
| 10 | Functionality Device |
| 12 | Functionality Device Attachment Unit |
| 14 | Device Instructions Indicia |
| 16 | Product Attribute Indicia |
| 18 | Attachment Unit |
| 20 | Auxiliary Panel(s) |

### DETIALED DESCRIPTION

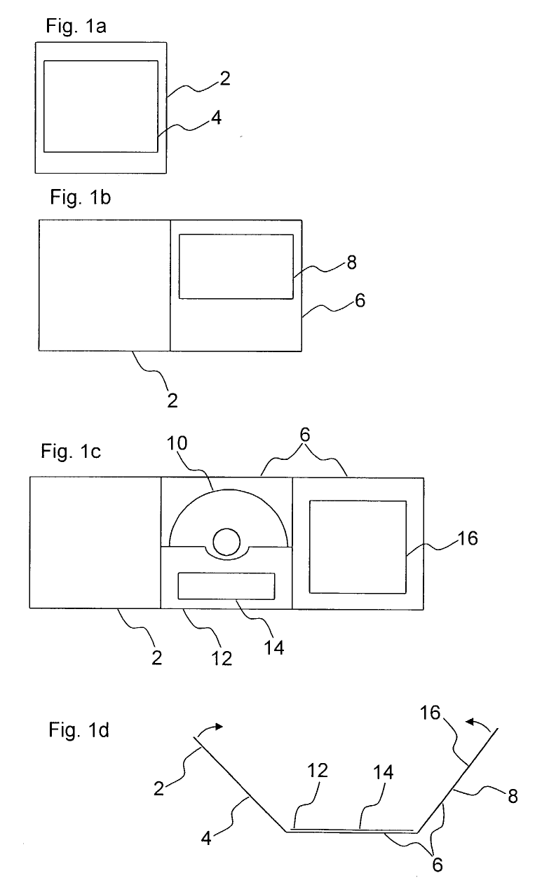

Referring to the drawings, FIGS. 1a through 1d show views of a greeting card product constructed in accordance with the present invention. FIG. 1a shows the greeting card's Front Panel (2), which contains the Front Indicia (4).

FIG. 1b shows the greeting card as it looks upon opening the Front Panel (2). It reveals an Interior Panel (6), which contains the Interior Indicia (8) and space to write a personal message. The reverse side of the Front Panel (2) is left blank to allow for additional personalization. The Front Panel (2) and Interior Panels (4) are made of substantially durable material such as cardboard, cardstock, plastic or textile.

FIG. 1c shows the greeting card as it looks when all of the Interior Panels (6) have been opened. Opening all of the Interior Panels (6) reveals a Functionality Device in the form of a CD (10), which supplies the user with interactive computer-based functionality that relates either to the Occasion (an occasion, holiday, or other event for which it may be desirable to give a greeting card) associated with the indicia on the greeting card, or to the Demographic Profile (the aspects of a person's life or life stage, such as age, gender, marital status, etc., as well as those things that relate to a particular aspect of a person's life or life stage, such as health status, intellectual capacity, hobbies, interests, etc.) of the recipient for which the greeting card's indicia is intended. An example of functionality related to an Occasion would be a collection of information about romantic films, accompanied by a searchable database to enable the user to identify movies that have certain attributes, and said functionality is associated with a Valentine's Day greeting card. An example of functionality related to a Demographic Profile would be an age-appropriate quiz related to a Birthday greeting card intended for a 5-year-old child.

The greeting card receives the Functionality Device (10) with a Functionality Device Attachment Unit (12), in this case a pocket that has been added to an Interior Panel (6). In addition, the Interior Panels (6) contain optional Device Instructions Indicia (14), which give the user instructions about how to begin using the Functionality Device (10), and the Interior Panels (6) contain optional Product Attribute Indicia (16), which enable communicating to the user the functionality and benefits of the greeting card and its Functionality Device.

FIG. 1d shows the greeting card as it looks with its panels opened but not fully extended. The intent in this figure is to show the folding direction of the Front Panel (2) and Interior Panels (6) and the facing positions of the various Indicia (4), (8), (14) and (16), and of the Functionality Device Attachment Unit (12).

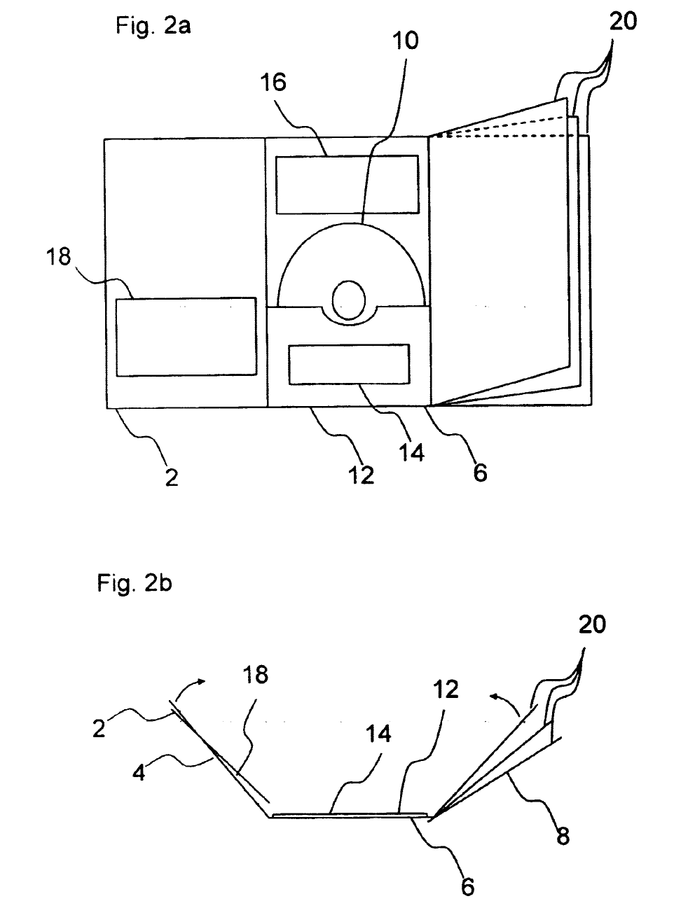

FIGS. 2a and 2b show an alternative embodiment of the physical design of a greeting card constructed in accordance with the present invention. The physical design shown in FIG. 2a is an alternative to the physical design shown in FIG. 1c. In this alternative,

the Interior Panels (6) contain Attachment Units (18), in this case a pocket and an area of semi-permanent adhesive, which enable the greeting card to receive various outside materials and memorabilia associated with using the Functionality provided by the Functionality Device.

FIG. 2b shows the greeting card of FIG. 2a as viewed from the bottom, with its panels opened but not fully extended. The intent in this figure is to show the folding direction of the Front Panel (2) and Interior Panels (6) and the facing positions of the various Indicia (4), (8), (14) and (16), and Attachment Units (12) and (18).

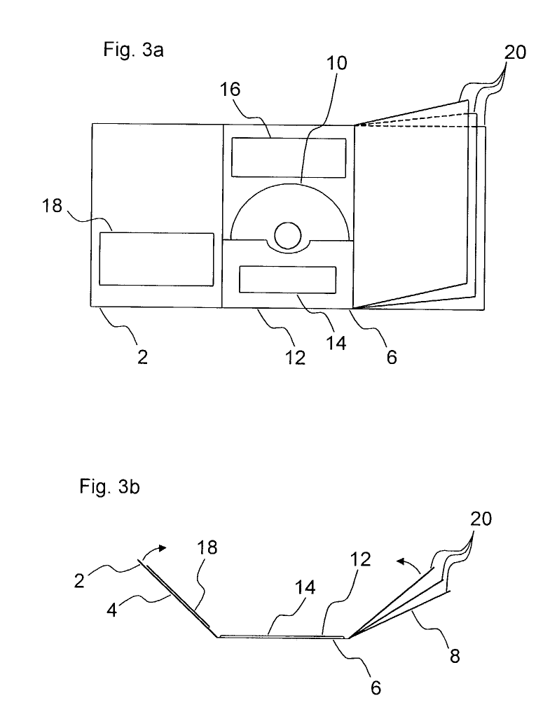

FIGS. 3a and 3b show an alternative embodiment of the physical design of a greeting card constructed in accordance with the present invention. The physical design shown in FIG. 3a is an alternative to the physical design shown in FIG. 1c. In this alternative,

the reverse side of the Front Panel (2) contains an Attachment Unit (18), in this case a pocket, for receiving outside materials and memorabilia associated with using the functionality provided by the Functionality Device (10),

the location of the Product Attribute Indicia (16) is included in an Interior Panel (6), and

Auxiliary Panels (20) have been added and bound at a common edge in book-binding fashion, and are made of material that is useful for note-taking, scrap-booking, and other activities.

FIG. 3b shows the greeting card as it looks with its panels opened but not fully extended. The intent in this figure is to show the folding direction of the Front Panel (2), Interior Panel(s) (6), Auxiliary Panels (20) and the facing positions of the various Indicia (4), (8), (14) and (16), and Attachment Units (12) and (18).

### Additional Embodiments

In an additional embodiment, said greeting card product combines a greeting card with a functionality device relating to the occasion being commemorated or to the demographic profile of the recipient. One or more of the panels contain a message for the recipient. The functionality is stored on a storage medium and the greeting card contains a means of receiving the medium. The functionality device refers to a mechanical device that enables the user to interact with said interactive computer-based functionality; it comprises software stored on a computer-readable storage medium, optional input and output devices, optional central processing units (CPUs), and other optionally included peripherals that support the user's interaction with said functionality.

In an additional embodiment, said greeting card product combines a greeting card with a functionality device relating to the occasion being commemorated or to the demographic profile of the recipient. Said functionality device contains a quiz and the greeting card contains a means of receiving the device.

In an additional embodiment, said greeting card product combines a greeting card with a functionality device relating to the occasion being commemorated or to the demographic profile of the recipient. Said functionality device contains a game and the greeting card contains a means of receiving the device.

In an additional embodiment, said greeting card product combines a greeting card with a functionality device relating to the occasion being commemorated or to the demographic profile of the recipient. Said functionality device contains a database and the greeting card contains a means of receiving the device.

In an additional embodiment, said greeting card product combines a greeting card with a functionality device relating to the occasion being commemorated or to the demographic profile of the recipient. Said functionality device contains a problem solving or creative tool and the greeting card contains a means of receiving the device.

In an additional embodiment, said greeting card product combines a greeting card with a functionality device relating to the occasion being commemorated or to the demographic profile of the recipient. Said functionality device contains a searchable database with films, movie clips, and other videos and the greeting card contains a means of receiving the device.

In an additional embodiment, said greeting card product combines a birthday greeting card with a functionality device, with optional additional pages and interior pockets. The front cover and/or interior panel(s) contain a birthday message, along with space for adding a personal message.

In an additional embodiment, said greeting card product combines a birthday greeting card with a functionality device, with optional additional pages and interior pockets. The front cover and/or interior panel(s) contain a birthday message, along with space for adding a personal message. Said functionality device contains a quiz relating to the recipient's demographic profile.

In an additional embodiment, said greeting card product combines a birthday greeting card with a functionality device. The front cover and/or interior panel(s) contain a birthday message, along with space for adding a personal message. Said functionality device contains a game relating to the recipient's demographic profile.

In an additional embodiment, said greeting card product combines a birthday greeting card with a functionality device. The front cover and/or interior panel(s) contain a birthday message, along with space for adding a personal message. Said functionality device is a handheld game relating to the recipient's demographic profile, such as a credit card-sized handheld game with a keypad and display screen.

In an additional embodiment, said greeting card product combines a birthday greeting card with a functionality device. The front cover and/or interior panel(s) contain a birthday message, along with space for adding a personal message. Said functionality device contains a searchable database of information, such as information regarding popular movies or astrological signs.

In an additional embodiment, said greeting card product combines a birthday greeting card with a functionality device. The front cover and/or interior panel(s) contain a birthday message, along with space for adding a personal message. Said functionality device contains a problem-solving or creative tool, such as a tool with pertinent information to help in planning a vacation.

In an additional embodiment, said greeting card product combines a congratulatory greeting for expectant or new parents with a functionality device, with optional additional pages and interior pockets. The front cover and/or interior panel(s) contain a congratulatory message, along with space for adding a personal message. The interior or other panel contains a means of holding said functionality device.

In an additional embodiment, said greeting card product combines a congratulatory greeting card for expectant parents with a functionality device. The front cover and/or interior panel(s) contain a congratulatory message, along with space for adding a personal message. Said functionality device contains a database, such as a searchable database of names, enabling the expectant parents to choose a name for the baby in a new and fun way.

In an additional embodiment, said greeting card product combines a Valentine's Day card with a functionality device, with optional additional pages and interior pockets. The front cover and/or interior panel(s) contain a Valentine's message, along with space for adding a personal message. The interior or other panel contains a means of holding said functionality device.

In an additional embodiment, said greeting card product combines a Valentine's Day greeting card with a functionality device, with optional additional pages and interior pockets. The front cover and/or interior panel(s) contain a Valentine's message, along with space for adding a personal message. Said functionality device contains a database, such as a searchable database of information regarding popular romantic movies.

In an additional embodiment, said greeting card product combines a Valentine's Day greeting card with a functionality device, with optional additional pages and interior pockets. The front cover and/or interior panel(s) contain a Valentine's message, along with space for adding a personal message. Said functionality device contains means to view a romantic film, and a searchable database of information regarding facts about the film.

In an additional embodiment, said greeting card product combines a Valentine's Day greeting card with a functionality device. The front cover and/or interior panel(s) contain a Valentine's message, along with space for adding a personal message. Said functionality device contains a quiz, such as a quiz about a couple's knowledge of one another.

In an additional embodiment, said greeting card product combines a Valentine's Day greeting card with a functionality device and a pocket for organizing keepsakes. The front cover and/or interior panel(s) contain a Valentine's message, along with space for adding a personal message. Said functionality device contains a tool, such as a tool for planning a romantic date. Said pocket enables recipient to keep menus, receipts, or other keepsakes from his/her date.

In an additional embodiment, said greeting card product combines an everyday love greeting card with a functionality device, with optional additional pages and interior pockets. The front cover and/or interior panel(s) contain a love message, along with space for adding a personal message. The interior or other panel contains a means of holding said functionality device.

In an additional embodiment, said greeting card product combines a wedding card with a functionality device, with optional additional pages and interior pockets. The front cover and/or interior panel(s) contain a wedding or congratulatory message, along with space for adding a personal message. The interior or other panel contains a means of holding said functionality device.

In an additional embodiment, said greeting card product combines a wedding greeting card with a functionality device. The front cover and/or interior panel(s) contain a wedding or congratulatory message, along with space for adding a personal message. Said functionality device contains a quiz, such as a quiz about a couple's knowledge of one another.

In an additional embodiment, said greeting card product combines a wedding greeting card with a functionality device. The front cover and/or interior panel(s) contain a wedding or congratulatory message, along with space for adding a personal message. Said functionality device contains a database, such as a searchable database of wedding traditions, history, and customs from around the world.

In an additional embodiment, said greeting card product combines an everyday friendship card with a functionality device, with optional additional pages and interior pockets. The front cover and/or interior panel(s) contain a wedding or congratulatory message, along with space for adding a personal message. The interior or other panel contains a means of holding said functionality device.

In an additional embodiment, said greeting card product combines a Mother's Day card with a functionality device, with optional additional pages and interior pockets. The front cover and/or interior panel(s) contain a Mother's Day message, along with space for adding a personal message. The interior or other panel contains a means of holding said functionality device.

In an additional embodiment, said greeting card product combines a Mother's Day card with a functionality device, along with interior pages for notes. The front cover and/or interior panel(s) contain a Mother's Day message, along with space for adding a personal message. The interior or other panel contains a means of holding said functionality device. Said functionality device provides a tool, such as a tool to help design a flower garden. Said interior pages can be used to take notes while interacting with said functionality device.

In an additional embodiment, said greeting card product combines a Christmas card with a functionality device, with optional additional pages and interior pockets. The front cover and/or interior panel(s) contain a Christmas message, along with space for adding a personal message. The interior or other panel contains a means of holding said functionality device.

In an additional embodiment, said greeting card product combines a Christmas card with a functionality device. The front cover and/or interior panel(s) contain a Christmas message, along with space for adding a personal message. The interior or other panel contains a means of holding said functionality device. Said functionality device contains a database, such as a searchable database of Christmas traditions from around the world.

In an additional embodiment, said greeting card product combines a children's birthday card with a functionality device, with optional additional pages and interior pockets. The front cover and/or interior panel(s) contain a birthday message, along with space for adding a personal message. The interior or other panel contains a means of holding said functionality device.

In an additional embodiment, said greeting card product combines a children's birthday card with a functionality device. The front cover and/or interior panel(s) contain a birthday message, along with space for adding a personal message. The interior or other panel contains a means of holding said functionality device. Said functionality device contains a quiz, such as a trivia quiz specific to the child's age or other demographic.

In an additional embodiment, said greeting card product combines a children's birthday card with a functionality device. The front cover and/or interior panel(s) contain a birthday message, along with space for adding a personal message. The interior or other panel contains a means of holding said functionality device. Said functionality device contains a game, such as an educational game specific to the child's age or other demographic.

In an additional embodiment, said greeting card product combines a graduation card with a functionality device, with optional additional pages and interior pockets. The front cover and/or interior panel(s) contain a graduation or congratulatory message, along with space for adding a personal message. The interior or other panel contains a means of holding said functionality device.

In an additional embodiment, said greeting card product combines a graduation card with a functionality device. The front cover and/or interior panel(s) contain a graduation or congratulatory message, along with space for adding a personal message. The interior or other panel contains a means of holding said functionality device. Said functionality device contains a database, such as a searchable database of life tips and pointers, covering a variety of topics.

In an additional embodiment, said greeting card product combines a Happy New Year card with a functionality device, with optional additional pages and interior pockets. The front cover and/or interior panel(s) contain a graduation or congratulatory message, along with space for adding a personal message. The interior or other panel contains a means of holding said functionality device.

In an additional embodiment, said greeting card product combines a Happy New Year card with a functionality device. The front cover and/or interior panel(s) contain a graduation or congratulatory message, along with space for adding a personal message. The interior or other panel contains a means of holding said functionality device. Said functionality device contains a database, such as a searchable database of information relating to champagne.

In an additional embodiment, said greeting card product combines a retirement card with a functionality device, with optional additional pages and interior pockets. The front cover and/or interior panel(s) contain a retirement or congratulatory message, along with space for adding a personal message. The interior or other panel contains a means of holding said functionality device.

In an additional embodiment, said greeting card product combines a retirement card with a functionality device. The front cover and/or interior panel(s) contain a retirement or congratulatory message, along with space for adding a personal message. The interior or other panel contains a means of holding said functionality device. Said functionality device contains a tool, such as a tool for retirement planning on various aspects of life.

In an additional embodiment, said greeting card product combines a get well soon card with a functionality device, with optional additional pages and interior pockets. The front cover and/or interior panel(s) contain a get-well message, along with space for adding a personal message. The interior or other panel contains a means of holding said functionality device.

In an additional embodiment, said greeting card product combines a get well soon card with a functionality device. The front cover and/or interior panel(s) contain a get-well message, along with space for adding a personal message. The interior or other panel contains a means of holding said functionality device. Said functionality device contains one or more games, such as fun games to brighten the recipient's day.

In an additional embodiment, said greeting card product combines a congratulatory card for someone buying a new home with a functionality device, with optional additional pages and interior pockets. The front cover and/or interior panel(s) contain a congratulatory message, along with space for adding a personal message. The interior or other panel contains a means of holding said functionality device.

In an additional embodiment, said greeting card product combines a congratulatory card for someone buying a new home with a functionality device. The front cover and/or interior panel(s) contain a congratulatory message, along with space for adding a personal message. The interior or other panel contains a means of holding said functionality device. Said functionality device contains a database, such as a searchable database of home decorating and repair tips.

It will be apparent that many changes and substitutions can be made to the embodiments herein described without departing from the spirit and scope of the present invention as defined by the appended claim. The above description contains many specifications, but they describe only some of the possible embodiments of this invention and should not be construed as limiting the invention's scope.

For example:

types of functionality may exist that have not been listed in this description;

one or more types of functionality may be combined in a single functionality device to provide functionality that has not been listed in this description;

occasions other than those identified in this description may exist, and the term occasion is used broadly to include any reason for giving any greeting card;

combinations of occasions and types of software may exist that are not listed in this description;

types of outside materials and memorabilia may exist that have not been listed in this description;

the card can include many different means for attaching outside materials and memorabilia, and functionality devices, including but not limited to pockets, permanent and semi-permanent adhesives, mechanisms similar to those found in Velcro, ties, snaps, buttons, hooks, etc., that are not listed in this description;

the front panel of the greeting card can be connected to any interior panel at any edge, or at any non-edge part of a panel, and not just at the left edge as shown in the illustrations;

any number of additional panels can be connected to the card, and a panel can be joined to any other panel at any edge, or at any non-edge part of a panel;

the functionality device has been portrayed as a compact disk in some embodiments of the description and illustrations, but other forms of computer-readable storage media may be used;

the functionality device has been portrayed as a compact disk in some embodiments of the description and illustrations, but as changing technology allows, the functionality device is expected to optionally incorporate central processing units (CPUs), and input and output devices; a present-day example of such a functionality device could be the calculator that has the dimensions of a credit card;

there may be ways of relating the functionality device to the greeting card's occasion indicia that have not been identified in this description; and

the term “demographic profile” is intended to include all aspects of a person's life or life stage, such as age, gender, marital status, etc., as well as those things that relate to a particular demographic profile, such as health status, intellectual capacity, hobbies, interests, etc.

### OBJECTS AND ADVANTAGES

Several objects and advantages of our invention are:

(a) To provide an innovation in the mature greeting card industry, and offer a high level of interactivity through computing-based media;

(b) To provide a gift/greeting card product that is different from traditionally-available card selections;

(c) To provide a fun gift/greeting card product;

(d) To provide a gift/greeting card product that is produced in such a way that said cards can be profitably sold in the price range of typical greeting cards;

(e) To provide a gift/greeting card product with a design similar to that of traditional greeting cards that does not substantially affect the thickness or packaging of the greeting card;

(f) To provide a gift/greeting card product that does not require special display at retailers;

(g) To provide a gift/greeting card product which can be sized in such a manner that it can be packaged in an envelope that is sized for easy mailing, without special packaging or a trip to the post office required;

(h) To provide a gift/greeting card product that can either act as a standalone gift or a standalone greeting card, fulfilling both needs of a consumer;

(i) To provide a gift/greeting card product that relates back to the occasion, event, or holiday being commemorated, providing lasting value to the recipient;

(j) To provide a gift/greeting card product that is both appropriate for the occasion, event, or holiday being commemorated and that enables and encourages the recipient to interact with it after the time at which it was received, thereby providing additional meaning and utility to the recipient beyond the time of receipt;

(k) To provide a gift/greeting card product that is both appropriate for the occasion, event, or holiday being commemorated and that enables and encourages the recipient to interact with it after the time at which it was received, thereby providing additional utility to the giver beyond the time of receipt because his or her sentiment continues to be received by the recipient each time the recipient interacts with the gift/greeting card product; and,

(l) To provide a new way of marketing a software product and greeting card as one product.

Further objects and advantages of our invention will become apparent from a consideration of the drawings and descriptions.

We claim:

1. A greeting card product, including:
A greeting card having indicia associated with an occasion, holiday, or other event; and a device for providing interactive computer-based functionality related to the occasion, holiday, or other event associated with the indicia on the greeting card or to the recipient's demographic profile.

2. The greeting card product of claim 1 wherein the product consists substantially of the greeting card and device.

3. The greeting card product of claim 1 wherein said device provides a quiz for the recipient related to the occasion, holiday, or other event associated with the indicia on the greeting card or to the recipient's demographic profile.

4. The greeting card product of claim 1 wherein said device contains a game related to the occasion, holiday, or other event associated with the indicia on the greeting card or to the recipient's demographic profile.

5. The greeting card product of claim 1 wherein said device provides a database of information related to the occasion, holiday, or other event associated with the indicia on the greeting card or to the recipient's demographic profile.

6. The greeting card product of claim 1 wherein said device provides a tool for the recipient related to the occasion, holiday, or other event associated with the indicia on the greeting card or to the recipient's demographic profile.

7. The greeting card product of claim 1 wherein said device provides a searchable database with films, movie clips or other videos related to the occasion, holiday, or other event associated with the indicia on the greeting card or to the recipient's demographic profile.
